(19) United States
(12) Patent Application Publication
(10) Pub. No.: US 2006/0135129 A1
(43) Pub. Date: Jun. 22, 2006

(54) System and method for transmitting MIDlet data using SMS

(75) Inventor: Dong-Kuk Park, Hwaseong-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/265,856

(22) Filed: Nov. 3, 2005

(30) Foreign Application Priority Data
Nov. 12, 2004 (KR) P2004-92403

(51) Int. Cl. H04L 12/58

(52) U.S. Cl. 455/412.1; 455/414.1

(57) ABSTRACT

A system and method for transmitting MIDlet data via a SMS are provided. In the system, at least one MIDlet one of generates an SMS message requesting a service and transmits the SMS message, and receives an SMS message requesting a service. An SMSC analyzes the SMS message received from the at least one MIDlet and, according to the analysis, forwards the SMS message to a receiving MIDlet or transmits to a servlet a remote method invocation (RMI) request included in the SMS message in a form suitable for processing in the servlet. The servlet analyzes the RMI request received from the SMSC, generates a return value in the form of an object, and transmits a return message having the return value for the at least one MIDlet.

### PRIORITY

This application claims priority under 35 U.S.C. § 119 to an application entitled “System and Method for Transmitting MIDlet Data Using SMS” filed in the Korean Intellectual Property Office on Nov. 12, 2004 and assigned Serial No. 2004-92403, the contents of which are incorporated herein by reference.

### BACKGROUND OF THE INVENTION

1. Field of the Invention

The present invention relates generally to a method of controlling a wireless networking-based MIDlet, and in particular, to a system and method for transmitting MIDlet data using a SMS (Short Message Service) in order to provide a RMI (Remote Method Invocation) between a MIDlet and a servlet and enable a data transmission between MIDlets.

2. Description of the Related Art

Most of the existing mobile terminals send normal text messages, WAP (Wireless Application Protocol) push messages, smart messages, and EMS (Enhanced Message Service) messages as SMS messages. The technology of sending Java objects similar in concept to user information or records such as files by SMS is an area for further study and deliberation.

To enable the transmission of Java objects or records in a wireless network environment, HTTP (HyperText Transfer Protocol)-based RMI was proposed. In a JAVA application, a MIDlet runs on an RTOS (Real Time Operating System)-based JAVA VM (Virtual Machine) and runs in the environment of the J2ME (Java 2 Micro Edition) CLDC/CDC (Connected Limited Device Configuration/Connected Device Configuration) and the MIDP (Mobile Information Device Profile) of Sun Micro Systems. However, the MIDlets are now developed and used in a very limited range including games in mobile terminals.

The Java technology is not fully utilized due to the limited memory capacity, the slow network environment, and the limitations of user input devices. Hence, it has not yet reached the developmental level that provides a variety of functions.

Recent years have witnessed the application of the Java Technology to a wide range including call, browsing, and messaging along with the rapid development of mobile terminals. An example of this trend is JavaPhone. Also, Java developers additionally provide APIs (Application Programming Interfaces) that were available in the existing J2SE (Java 2 Standard Edition), yet not provided in the J2ME due to a limited program execution environment, as well as conventional MIDP APIs. A main example of such additionally provided APIs is RMI.

RMI is a protocol that enables message transmission between distributed objects. An HTTP-based RMI sends and receives an input value and a final return value of a method to be invoked along with the URL (Uniform Resource Locator) information of a servlet having an object of interest by the HTTP Post/Get Command.

HTTP is not an easy protocol to utilize in a wireless networking-based mobile computing environment. The use of the HTTP-based RMI is inefficient, which will be described by the following example.

It is assumed that a communication service provider provides a service by which a MIDlet-enabled mobile terminal can search and read personal data in a predetermined data service.

If the user of the mobile terminal wants to access a server operated by the communication service provider using the URL of the server, request a search for intended personal data by HTTP-based RMI, and receive a returned object corresponding to the search request, the terminal must establish a PPP connection through a GPRS (General Packet Radio Service) or a CSD (Circuit Switched Data) connection, and then establish a connection to a TCP/IP (Transmission Control Protocol/Internet Protocol) stack and socket, before it is able to request the search and receive the returned result. Particularly, the RMI is used for operations such as mathematical computing difficult at a client or for the searching of huge amounts of data beyond storage in most client/server environments.

### SUMMARY OF THE INVENTION

As described above, a PPP connection and a TCP/IP stack and socket connection are required before a message requesting an operation is sent and the result of the request is returned in the conventional HTTP-based RMI. Consequently, the HTTP-based RMI is inefficient.

Besides, to transmit/receive an object directly between peer MIDlets, one of the MIDlets must act as a server, which is difficult to implement.

An object of the present invention is to substantially solve at least the above problems and/or disadvantages and to provide at least the advantages below. Accordingly, an object of the present invention is to provide a system and method for transmitting MIDlet data by SMS in order to implement RMI between a MIDlet and a servlet by SMS and enable transmission of objects and records between MIDlets.

The above object is achieved by providing a system and method for transmitting MIDlet data by a SMS.

According to one aspect of the present invention, in a system for transmitting MIDlet data by a SMS, at least one MIDlet generates an SMS message requesting a service and transmits the SMS message, or receives an SMS message requesting a service. An SMSC analyzes the SMS message received from the at least one MIDlet and, according to the analysis, forwards the SMS message to a receiving MIDlet or transmits to a servlet a remote method invocation (RMI) request included in the SMS message in a form suitable for processing in the servlet. The servlet analyzes the RMI request received from the SMSC, generates a return value in the form of an object, and transmits a return message having the return value for the at least one MIDlet.

According to another aspect of the present invention, in a MIDlet data transmitting system including at least one MIDlet, and a sevlet connected to an SMSC, in a method of transmitting RMI request data from the at least one MIDlet to the servlet, the at least one MIDlet transmits the RMI request data by an SMS message to the servlet to receive a service from the servlet. The SMSC separated the RMI request data from the SMS message and transmits it in a form suitable for the servlet. The servlet transmits a return message in response to the RMI request data.

According to a further aspect of the present invention, in a method of transmitting an object from one MIDlet to another MIDlet, a first MIDlet generates an object to be sent as an SMS message and transmits it. A MIDlet ID is detected from the SMS message and the SMS message is transmitted to a second MIDlet corresponding to the MIDlet ID. The second MIDlet analyzes the SMS message and detects the object from the SMS message.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a system where objects and record data are transmitted by a SMS according to an embodiment of the present invention;

FIG. 2 is a diagram illustrating a message flow between a MIDlet and a servlet according to the embodiment of the present invention;

FIG. 3 illustrates the structure of an SMS message for requesting a service according to the embodiment of the present invention;

FIG. 4 is a table listing code values in an SMS message transmitted for requesting a service by the MIDlet according to the embodiment of the present invention;

FIG. 5 is a table listing code values in a return message transmitted by the servlet according to the embodiment of the present invention; and

FIG. 6 is a table listing code values in an SMS message transmitted for requesting a service from one MIDlet to another MIDlet according to another embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to implement major functionalities of the Java platform in a mobile computing environment, an RMI and transmission of serialized objects or records. For this purpose, the present invention enables an RMI between a MIDlet and a servlet and enables the transmission of objects and record data between MIDlets by SMS in mobile terminals or PDAs.

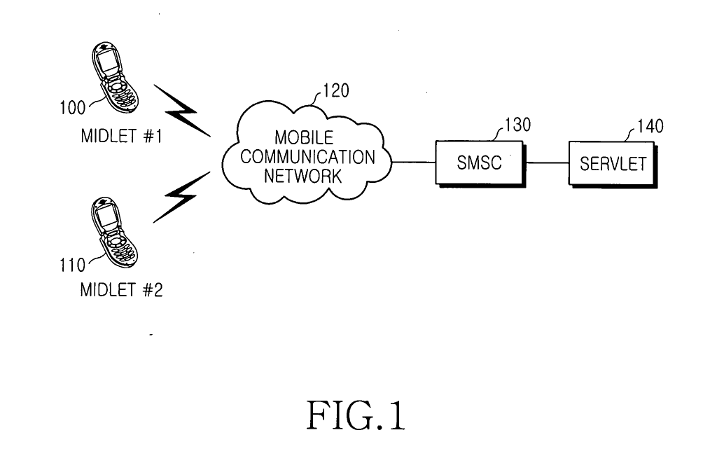

With reference to FIG. 1, the schematic configuration of a mobile communication system in which data is transmitted by an SMS according to the present invention will be described below. Referring to FIG. 1, the mobile communication system includes a first MIDlet 100, a second MIDlet 110, a mobile communication network 120, an SMS center (SMSC) 130, and a servlet 140.

The MIDlets 100 and 110 generate SMS messages requesting certain services and transmit/receive the SMS messages according to the present invention. To process the service requests from the MIDlets 100 and 110, the mobile communication network 120 interact with the SMSC 130.

The SMSC 130 is an independent node. The SMSC 130, connected to the mobile communication network 120, locates the MIDlets 100 and 110 and forwards the SMS messages to them according to the present invention. It also stores an SMS message for a receiving MIDlet for a predetermined time when the MIDlet cannot receive the SMS message, and forwards the SMS message to the MIDlet.

The SMSC 130 sends an SMS message originated from a MIDlet to a MIDlet at a destination address set in the SMS message, or an applet in service by the SMSC 130. The applet is connected to a URL set in the SMS message and requests a service, providing an object included in the SMS message in the present invention.

According to the embodiment of the present invention, the servlet 140 analyzes the service request from the applet on the SMSC 130, generates a return value in the form of an object, and sends the return value to the applet.

The servlet 140 provides the service requested by the applet on the SMSC 130, and the MIDlets 100 and 110 run on the J2ME platform, for the transmission/reception of objects to/from the applet. It is to be noted herein that the Java MIDlets are based on the J2ME RMI optional package, Specification v1.0.

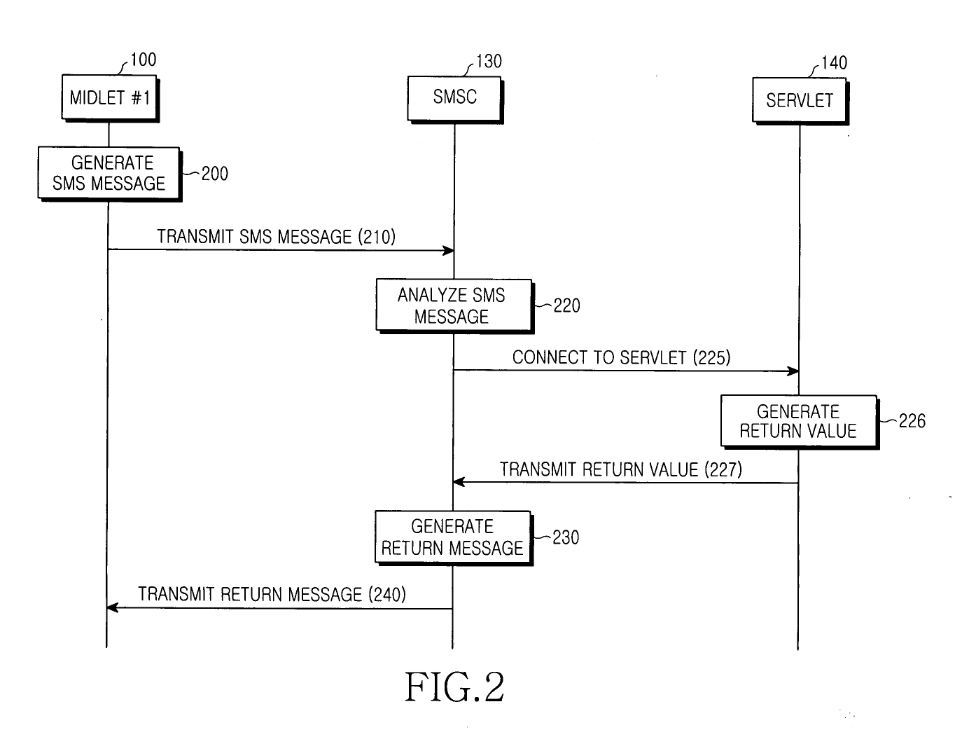

The transmission of objects and records by the SMS messages will be described with reference to FIG. 2. FIG. 2 is a diagram illustrating a message flow between a MIDlet and a servlet according to the embodiment of the present invention.

Referring to FIG. 2, the first MIDlet 100 generates an SMS message requesting a desired service using the URL of the servlet 140 that will provide the service, the ID (IDentifier) of a method to be invoked when necessary, and input parameters in step 200.

In step 210, the first MIDlet 100 sends the service-requesting SMS message to an applet on the SMSC 130. If the URL information and the amount of serialized object data is too much to be transmitted at one time, the SMS message is sent in the form of concatenated messages. The applet on the SMSC 130 extracts the URL information and the serialized object from the SMS message and requests the service from the servlet 140 via HTTP using the same URL and input object.

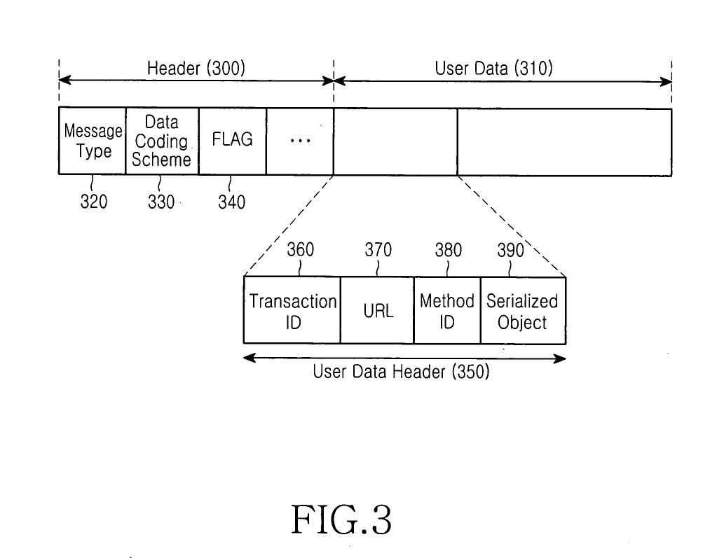

The service-requesting SMS message received at the applet on the SMSC 130 is formatted as illustrated in FIG. 3. Referring to FIG. 3, one SMS message frame is typically comprised of a Header 300 and User Data 310. The Header 300 includes a Message Type 320, a Data Coding Scheme 330, a Flag 340 indicating the presence or absence of a User Data Header 350 in the User Data 310, and other fields needed for transmission/reception of the SMS message.

The User Data 310 is a field having actual data that the sender intends to send to the receiver by the SMS message. Usually, it is 160 bytes long. For implementation of the present invention, the User Data Header 350 includes information related to a service request. The User Data 310 includes a Transaction ID 360, a URL 370, a Method ID 380, and a Serialized Object 390.

For example, when the first MIDlet 100 sends a service-requesting SMS message to the servlet 140, the first MIDlet 100 uses the above-described User Data Header 350 to indicate that the SMS message requests a service unlike other general SMS messages.

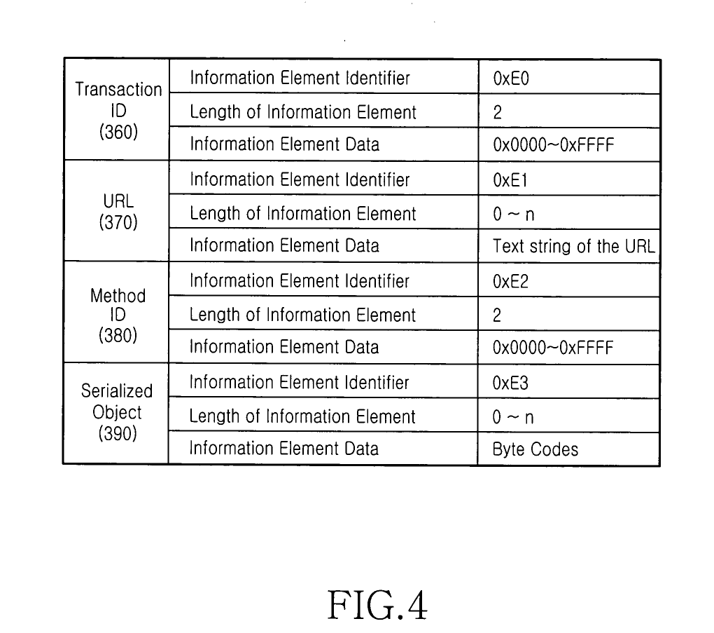

The fields of the User Data Header 350 may have code values as illustrated in FIG. 4 and each of the fields has the same elements. For example, they commonly have an Information Element Identifier, a Length of Information Element, and an Information Element Data. If the Information Element Identifier is a hexadecimal value, 0xE0, it identifies the Transaction ID 360. The fields are identified by the Information Element Identifier. If the Information Element Identifier is a hexadecimal value, 0xE1, it identifies the URL 370. The Information Element Data of the URL 370 indicates an actual URL in the form of text.

Upon receipt of the service-requesting SMS message, the applet analyzes the SMS message according to a known format structure. The applet analyzes the SMS message received form the first MIDlet 100 in step 220 and is connected to the servlet 140 using the URL information included in the SMS message in step 225. In step 226, the method set in the SMS message is invoked on the servlet 140 and a return value is generated. The return value is sent to the applet of the SMSC 130 in step 227.

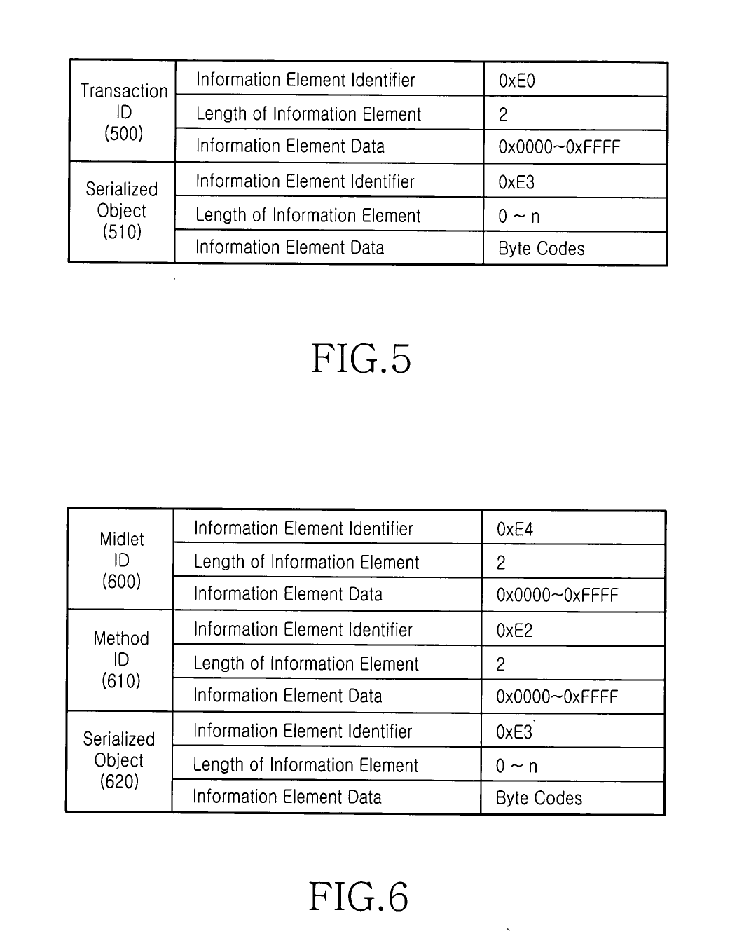

The applet sends an SMS message including the return value, with a User Data Header formatted as illustrated in FIG. 5 to the first MIDlet 100 in steps 230 and 240. The User Data Header includes a Transaction ID 500 and a Serialized Object 510. The first MIDlet 100 analyzes the User Data Header in this return SMS message and converts a byte code included in the SMS message to an object.

The transmission of a service-requesting SMS message from a MIDlet to a servlet according to the embodiment of the present invention has been described above. Now, a description will be made of the transmission of an SMS message for allowing data transmission between MIDlets according to another embodiment of the present invention. Here, data to be transmitted is object or record data.[WHAT IS MEANT BY “RECORD DATA”?]

After generating a byte code by an object serialization process, the first MIDlet 100 sends the serialized object to the second MIDlet 110 using a User Data Header formatted as illustrated in FIG. 6. Referring to FIG. 6, a MIDlet ID 600 identifies a MIDlet, and a Method ID 610 identifies a particular method in the MIDlet. For example, the Method ID 610 can be the ID of a service item to be used.

This SMS message is delivered to the second MIDlet 110 having the MIDlet ID set in the SMS message by a default SMS application on a receiving terminal. The second MIDlet 110 then extracts the serialized object and the MIDlet ID from the SMS message and deserializes the serialized object. Thus, a method corresponding to an action ID set by the second MIDlet 110 is invoked. For a record, the above operation is performed except that Information Element Identifier is 0xE6 unlike an object.

In accordance with the present invention, an RMI is provided by a SMS instead of an HTTP and an object can be transmitted from one mobile terminal to another terminal by a SMS. Therefore, a more light and efficient RMI protocol can be provided and various MIDlets can be produced in applications of the related technology to the mobile environment.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A system for transmitting MIDlet data via a short message service (SMS), comprising:
at least one MIDlet for generating an SMS message requesting a service and transmitting the SMS message, and receiving an SMS message requesting a service;
an SMS center (SMSC) for analyzing the SMS message received from the at least one MIDlet and, according to the analysis, forwarding the SMS message to a receiving MIDlet or transmitting to a servlet a remote method invocation (RMI) request included in the SMS message in a form suitable for processing in the servlet; and
a servlet for analyzing the RMI request received from the SMSC, generating a return value in the form of an object, and transmitting a return message having the return value for the at least one MIDlet.

2. The system of claim 1, wherein the at least one MIDlet generates a serialized object by converting information about the at least one MIDlet to a byte stream through a serialization process, and includes the serialized object in the SMS message.

3. The system of claim 2, wherein the SMS message includes the uniform resource locator (URL) of the servlet, a method identifier (ID) for identifying a service item to be invoked, an input parameter, and the serialized object.

4. The system of claim 3, wherein the URL, the method ID, the input parameter, and the serialized object are included in a user data header in the SMS message.

5. In a MIDlet data transmitting system including at least one MIDlet, and a sevlet connected to a short message service center (SMSC), a method of transmitting remote method invocation (RMI) request data from the at least one MIDlet to the servlet, comprising the steps of:
(1) transmitting the RMI request data by an SMS message to the servlet to receive a service from the servlet in the at least one MIDlet;
(2) separating the RMI request data from the SMS message and transmitting the RMI request data in a form suitable for the servlet in the SMSC; and
(3) transmitting a return message in response to the RMI request data in the servlet.

6. The method of claim 5, wherein the RMI request data includes a serialized object indicating information about the at least one MIDlet, the uniform resource locator (URL) of the servlet, a method identifier (ID) for identifying a service item to be invoked, and an input parameter.

7. The method of claim 5, wherein the RMI request data is included in a user data header in the SMS message.

8. The method of claim 6, wherein step (1) comprises the step of generating the serialized object by converting an object indicating the information of the at least one MIDlet to a byte stream through a serialization process.

9. The method of claim 5, wherein step (1) comprises the step of transmitting the SMS message in the form of concatenated SMS messages if the SMS message is too long in size to be transmitted at one time.

10. The method of claim 5, wherein step (3) is performed in an applet of the SMSC.

11. The method of claim 10, wherein step (3) comprises the step of transmitting modified RMI request data with the URL and object included in the RMI request data received from the at least one MIDlet by the applet.

12. The method of claim 10, further comprising the step of receiving the return message from the servlet, separating a return value from the return message, and transmitting the return value by an SMS message to the at least one MIDlet by the applet.

13. A method of transmitting an object from a first MIDlet to a second MIDlet, comprising the steps of:
(a) generating in a first MIDlet an object to be sent as a short message service (SMS) message and transmitting the SMS message;
(b) detecting a MIDlet identifier (ID) from the SMS message;
(c) transmitting the SMS message to a second MIDlet corresponding to the MIDlet ID; and
(d) analyzing the SMS message and detecting the object from the SMS message in the second MIDlet.

14. The method of claim 13, wherein the object is a serialized object being a byte stream produced by s serialization process and is included in a user data header of the SMS message.

15. The method of claim 14, wherein the user data header includes a MIDlet ID for identifying a MIDlet, and a method ID for identifying a method to be invoked.

16. The method of claim 15, wherein step (d) comprises the step of extracting the serialized object and the MIDlet ID from the SMS message, deserializing the serialized object, and invoking the method corresponding to the method ID in the second MIDlet.

17. The method of claim 13, further comprising the step of transmitting record data as an SMS message by the first MIDlet.
